(19) United States
(12) Patent Application Publication
(10) Pub. No.: US 2003/0075827 A1
(43) Pub. Date: Apr. 24, 2003

(54) Method of manufacturing components of plastics material liquid meters and components of liquid meters manufactured by this kind of method

(76) Inventors: Laurent Demia, Macon (FR); Michel Petite, Macon (FR)

Correspondence Address: STRAUB & POKOTYLO, 1 BETHANY ROAD, SUITE 83, BUILDING 6, HAZLET, NJ, 07730, US

(21) Appl. No.: 10/244,094

(22) Filed: Sep. 13, 2002

(30) Foreign Application Priority Data
Sep. 14, 2001 (FR) 01 11969

(51) Int. Cl. B29C 45/14

(52) U.S. Cl. 264/279; 264/279.1

(57) ABSTRACT

A method of manufacturing a liquid meter including various components such as a meter body, a measuring chamber, its cover or a piston and a mounting ring for a totalizer, consists of manufacturing at least one of the components by an injection molding process using a mold whose shape is adapted to the component to be manufactured by injecting a plastics material around a metal insert intended to form a portion of the core of a portion of one of the components.

### BACKGROUND OF THE INVENTION

1. Field of the Invention

The invention relates to a method of manufacturing a liquid meter and also to a liquid meter manufactured by a manufacturing method according to the invention.

2. Description of the Prior Art

A liquid meter generally includes various components such as a meter body, measuring means and a ring for mounting a totalizer. The method of manufacturing this kind of meter consists of manufacturing at least one of said components by injection molding a plastics material using a mold whose shape is adapted to said component to be manufactured.

The invention finds one particularly beneficial application in the field of oscillating piston volumetric liquid meters when some of the components are manufactured by injection molding a plastics material.

In the water meter art, some components of the meter have for many years been manufactured from a metal alloy such as brass. This material has good resistance to aging, and in particular the meteorological performance of the meter and its watertightness are maintained over time.

For many years water meter manufacturers have attempted to substitute plastics materials for brass. For example, U.S. Pat. No. 4,391,139 describes some portions of a water meter manufactured from plastics materials by an injection molding process. The various components forming the measuring chamber are manufactured by injection molding, each component being manufactured using a mold of appropriate shape. The injection molding process employed is a standard process well known to the person skilled in the art. The material employed is a thermoplastics material.

Plastics material water meter components have many advantages, such as the facility to modify their design to integrate new functions, a much more extensive range of colours than is possible with brass, a significant saving in weight, a saving in the cost of manufacture, a reduction in the noise generated by the meter in operation, and finally the elimination of problems associated with the pollution of drinking water in contact with brass. There nevertheless remains a major problem with water meter parts made from plastics materials because they do not offer good mechanical performance, which leads in particular to problems with resisting high fluid pressures and resisting aging. For example, cracks leading to leaks appear after a time period much shorter than the service life normally expected of a water meter.

An objective of the present invention is to alleviate the drawbacks previously cited by proposing a manufacturing method for manufacturing at least some of the components of a liquid meter directly by an injection molding process and with improved mechanical specifications, in order to improve the general performance thereof, for example to maintain their mechanical strength throughout the period of use of the meter.

### SUMMARY OF THE INVENTION

The above object is achieved by a method according to the invention consisting of manufacturing at least one of the components by an injection molding process using a mold whose shape is adapted to the component to be manufactured, the method consisting of injecting a plastics material around a metal insert intended to form a portion of the core of a portion of one of the components.

The insert advantageously has a particular shape adapted to the component to be manufactured.

The insert is preferably made of metal.

The above injection molding method produces a meter component having improved mechanical specifications directly from the mold, without the component requiring subsequent treatment.

Other features and advantages of the invention will emerge from the following detailed and nonlimiting description of various embodiments of the invention, which is given with reference to the accompanying drawings.

### BRIEF DESCRIPTION OF THE DRAWINGS

FIG. 1 is a sectional view of a meter body manufactured by a first embodiment of a method according to the invention.

FIGS. 2.A to 2.F are diagrammatic part-sectional views of a totalizer force-fitted onto a mounting ring adapted to be screwed onto a meter body, said ring being manufactured by a number of variants of a second embodiment of a method according to the invention.

FIG. 3.A is a diagrammatic sectional view of a measuring chamber whose cover is fabricated by a first variant of a third embodiment of a method according to the invention.

FIG. 3.B is a diagrammatic sectional view of a measuring chamber whose piston is fabricated by a second variant of a third embodiment of a method according to the invention.

FIG. 3.C is a diagrammatic sectional view of a measuring chamber whose piston is fabricated by a third variant of a third embodiment of a method according to the invention.

FIG. 3.D is a diagrammatic sectional view of a measuring chamber whose bottom is fabricated by a fourth variant of a third embodiment of a method according to the invention.

FIG. 3.E is a diagrammatic sectional view of a measuring chamber whose bottom is fabricated by a fifth variant of a third embodiment of a method according to the invention.

FIG. 4 shows one particular embodiment of a metal insert used in the manufacture of the measuring chambers shown in FIGS. 3.A, 3.B and 3.D.

### DETAILED DESCRIPTION OF THE PREFERRED EMBODIMENTS

The following description relates to a volumetric meter. The person skilled in the art will nevertheless be easily able to apply this meter manufacturing method to other types of meters, for example speed meters.

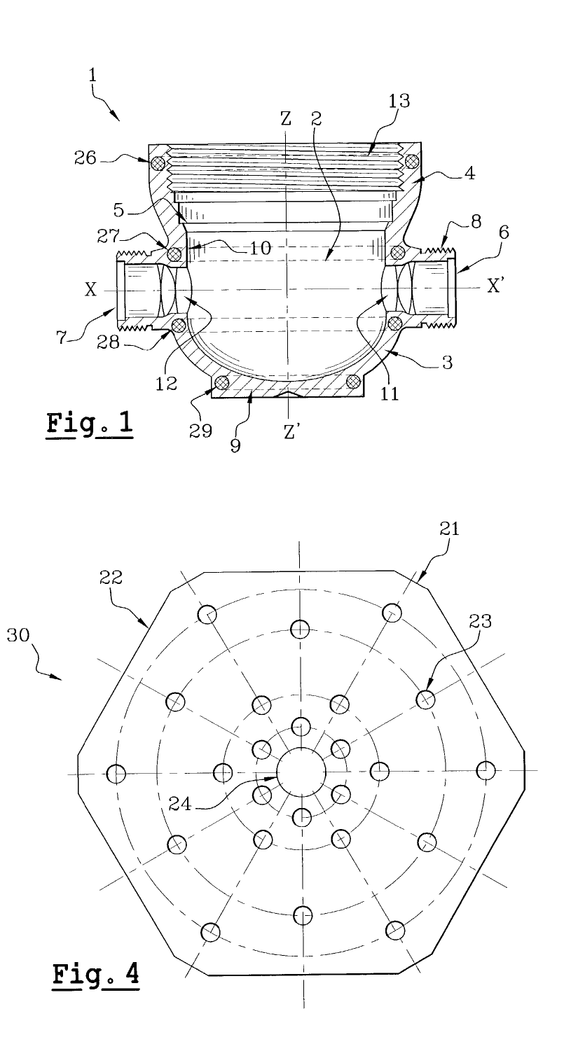

The meter body shown in FIG. 1 includes a bucket 1 having an axis of symmetry ZZ′. The bucket is in one piece and comprises a lower portion 3 and an upper portion 4. The lower portion 3, which defines a housing 2 into which a measuring chamber is inserted, is delimited by a bottom 9 and by a cylindrical lower lateral wall 10. The upper portion 4 is delimited by an upper lateral wall which is also cylindrical and incorporates a thread 13. The lateral walls of the two portions are joined together by a shoulder 5.

The meter body includes a substantially cylindrical inlet tube 6 and a substantially cylindrical outlet tube 7, each of which has an outside thread 8. Each of the tubes opens into the measuring chamber 2 via a bore formed in the lower lateral wall 10 of the measuring chamber 2, respectively forming an injector 11 and an ejector 12. The injector and the ejector have a common axis XX′ perpendicular to the axis ZZ′.

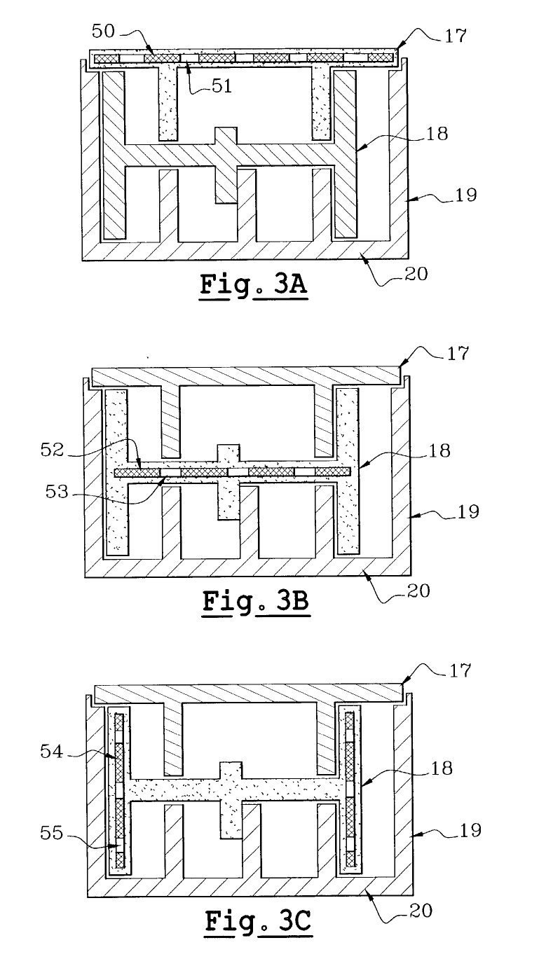

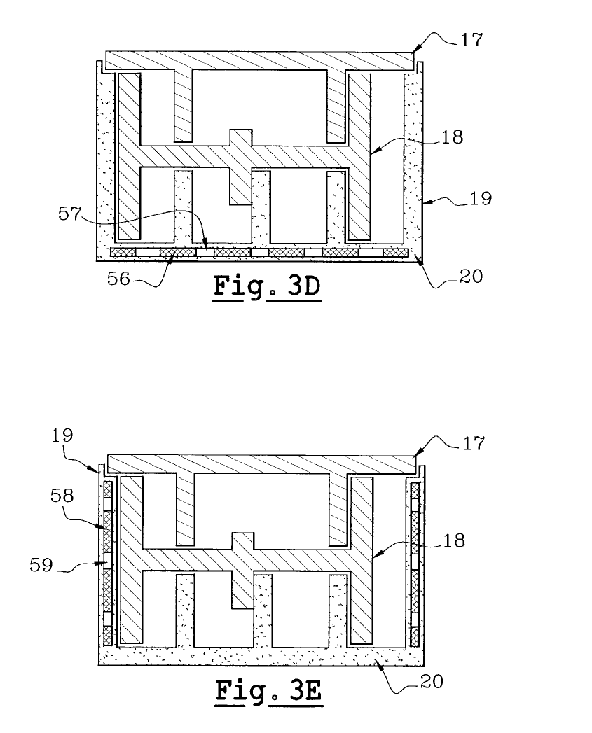

The lower portion 3 delimits the housing of the measuring chamber of the meter in which a turbine, a screw, or an oscillating piston, for example, is mounted, depending on the meter type. FIGS. 3.A to 3.E show a measuring chamber for an oscillating piston volumetric meter.

In a first embodiment of the invention, the meter body has at least one annulus 26, 27, 28, 29 embedded in the plastics material constituting the body of the meter. The annulus is preferably made of metal, for example stainless steel or brass. Other types of materials having similar mechanical strength characteristics to metals can be envisaged. The annulus can have various sections depending on the required strength or the space available. It can also be advantageous to provide the annulus with at least one hole for good fastening together of the insert and the injected plastics material forming the meter body.

The function of this annulus, respectively these annuli, is to reinforce fragile areas that may appear in time as the meter is used. The advantage of this embodiment is the improvement in the mechanical strength and the limitation of the deformation of the meter body when the latter is subjected to stresses such as ramming or a static pressure.

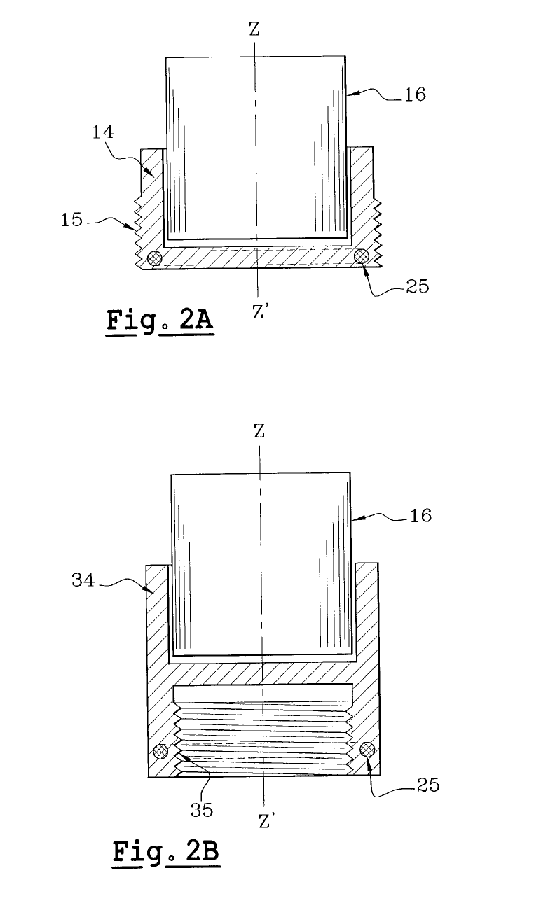

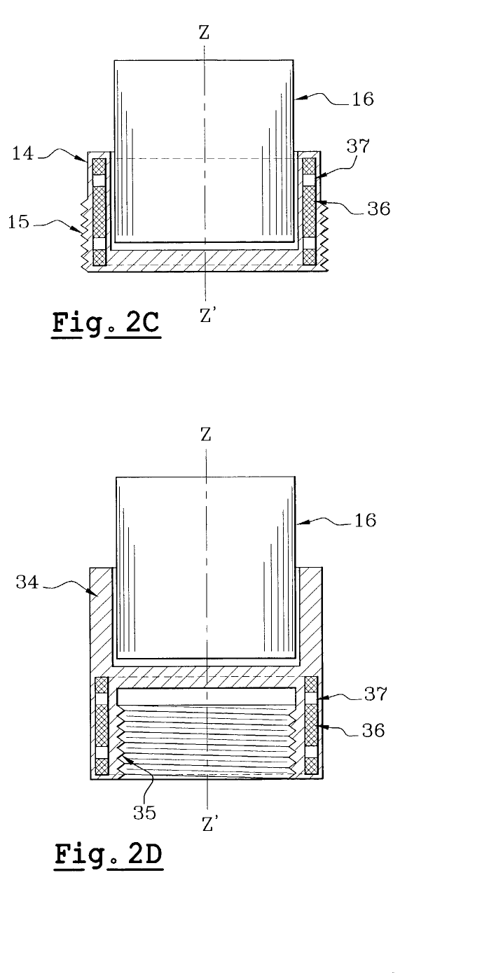

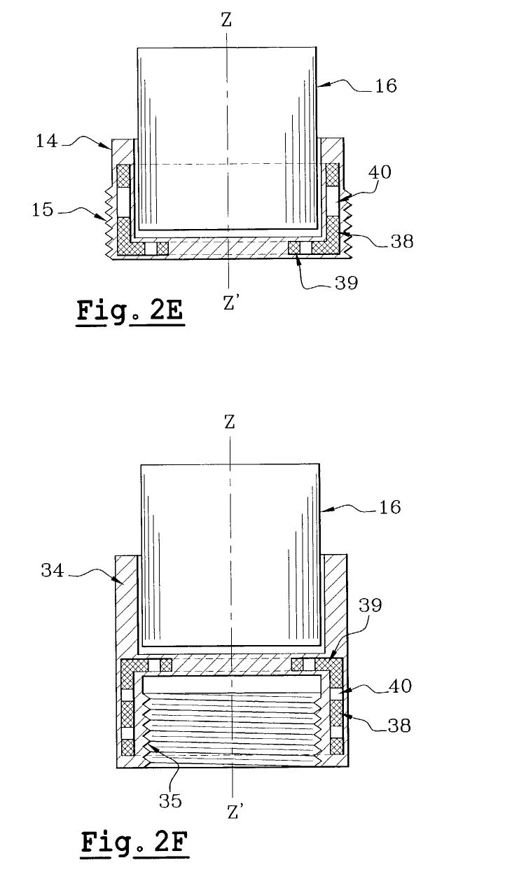

In a first variant of this embodiment, an annulus 26 is placed in the upper portion 4. An additional advantage of this annulus 26 is that it reinforces the thread 13 in the area of fixing said meter body to the mounting ring 14, 34 of the totalizer 16 (see FIGS. 2.A to 2.F).

In a second variant of the above embodiment, an annulus 27 is placed in the lower lateral wall 10, above the area in which the tubes 6, 7 open into the measuring chamber 2, respectively forming an injector 11 and an ejector 12.

In a third variant of the above embodiment, an annulus 28 is placed in the lower lateral wall 10 below the area in which the tubes 6, 7 open into the measuring chamber 2, respectively forming an injector 11 and an ejector 12.

In accordance with a fourth variant of the above embodiment, an annulus 29 is placed in the bottom 9 of the lower portion 3.

Combining all the foregoing variants to obtain a meter body 1 as shown in section in FIG. 1 can of course be envisaged.

The annuli shown in FIG. 1 have a circular section. Other shape sections can nevertheless be envisaged.

The method of manufacturing the meter body consists of injecting a plastics material around at least one insert intended to form a portion of the core of the meter body. The shape of the mold is adapted to the meter body. The insert for this embodiment takes the form of an annulus. The insert is preferably made of metal. It can have at least one hole pierced in it. In the variants envisaged, the annulus 26, 27, 28, 29 is placed in the mold inside the upper portion 4, above and/or below the injector 11 and the ejector 12, and/or in the bottom 9, respectively. After positioning the metal insert or inserts in the mold by means of retaining studs, the plastics material is injected to fill the mold.

The upper portion 4 of the meter body is intended to receive a totalizer 16 whose function is to convert the quantity of liquid that has passed through the meter into a number that can be read by or otherwise communicated to an external user and corresponding to the measured liquid volume. A totalizer and its screwing or mounting ring are shown diagrammatically and partly in section in FIGS. 2.A to 2.F. The totalizer 16 is force-fitted to a mounting ring 14, 34. In FIGS. 2.A, 2.C and 2.E, the ring 14 has a thread 15 and is fixed into the meter body in the upper portion 4. In FIGS. 2.B, 2.D and 2.F, the ring 34 has an inside thread 35 and is designed to cap the meter body. In this case, the meter body has a thread on the outside of the upper portion 4, instead of on the inside, as shown in FIG. 1. The function of the ring 14, 34 is to close the upper portion of the meter body and to secure the totalizer to the meter body. An alternative solution is to integrate the screwed ring into the totalizer so that the combination forms a single component to be screwed into the upper portion 4 of the meter body.

In a second embodiment of the invention, the ring 14, 34 includes at least one annulus 25, 36, 38 embedded in the plastics material constituting the ring. The annulus is preferably made of metal, for example stainless steel or brass. The annulus can have various sections depending on the required strength or the space available. In FIGS. 2.A and 2.B, the annulus 25 has a circular section. In FIGS. 2.C and 2.D, the annulus 36 has a rectangular section. In FIGS. 2.E and 2.F, the annulus 38 has an L-shaped section corresponding to an annulus of rectangular section as shown in FIGS. 2.C to 2.D provided with a flange 39 directed toward the axis ZZ′ of the ring.

In all the above variants piercing holes 37, 40 in the annulus 25, 36, 38 to improve the fastening together of the annulus and the injected plastics material forming the ring can be envisaged.

The function of the annulus is to improve the strength of the screwing ring 14, 34. The advantage of this embodiment is the limitation of the deformation of the ring, which can jam moving parts such as gears in the totalizer.

The method of manufacturing the ring 14, 34 and/or the totalizer with an integral ring consists of injecting a plastics material around at least one metal insert in the form of an annulus. The shape of the mold is adapted to the ring or the totalizer. After positioning the annulus 25, 36, 38 in the mold with the aid of retaining studs, and level with the thread 15 or the thread 35, as appropriate, the plastics material is injected to fill the mold.

FIGS. 3.A to 3.E show a measuring chamber for an oscillating piston volumetric meter designed to be accommodated in the measuring chamber 2 of the meter body 1. The measuring chamber is a cylindrical chamber formed from various components: a lower portion including a lateral wall 19 and a bottom 20, over which is nested an upper portion incorporating a cover 17. A cylindrical piston 18 whose diameter is less than that of the chamber is positioned eccentrically within the chamber. The piston 18 has at its mid-height a plane wall supporting at its center two nipples, one directed toward the bottom and the other toward the cover. The bottom and the cover have at least one inlet and one outlet (not shown) for admitting fluid to the chamber and evacuating it therefrom, respectively. The chamber also has a fixed partition (not shown) separating the inlet from the outlet. The chamber generally has a peripheral seal (not shown) intended to force the liquid to flow across the measuring chamber and to prevent direct flow of the liquid from the inlet tube to the evacuation tube of the meter.

In a third embodiment of the invention, at least one of the components of the measuring chamber includes a metal insert embedded in the plastics material. The insert is preferably made of metal, for example stainless steel or brass. The insert can have various shapes and thicknesses depending on the required strength and the available space.

For example, FIG. 4 shows an insert in the form of a hexagonal metal plate 30. The plate 30 has six equidistant flats 22, each corner 21 being radiused to center the plate in the mold. The plate 30 is pierced with regularly spaced holes 23 and a central hole 24, the holes improving the covering of the plate by the injected plastics material and the adhesion between them. Obviously, the number and the position of the holes can be modified without degrading the function of the component. Other shapes of plate can be envisaged, for example a circular metal plate.

In a first variant of the embodiment shown in FIG. 3.A, the cover 17 of the measuring chamber includes a metal plate 50 embedded in the plastics material constituting said cover. The plate 50 can be pierced with at least one hole 51 to improve the injection process and the adhesion of the plastics material to the plate. The method of manufacturing the cover 17 consists of injecting a plastics material around at least one metal insert in the form of a plate. The shape of the mold is adapted to the cover. The plate 50 is positioned in the mold and retained by means of nipples, after which the plastics material is injected to fill the mold.

The cover being subjected to the pressure of the liquid passing through the meter, and also to ramming and to impacts of the oscillating piston, with the manufacturing method according to the invention the cover offers improved strength and reduced deformation compared to the prior art cover. Also, the general shape of the cover is simplified because it is no longer necessary for it to be ribbed for high stiffness.

In a second variant of the embodiment shown in FIG. 3.B, the plane wall of the piston 18 of the measuring chamber includes a metal plate 52 embedded in the plastics material constituting said piston. The plate 52 can be pierced with at least one hole 53 to improve the injection molding process and the adhesion of the plastics material to the plate. The method of manufacturing the piston consists of injecting a plastics material around at least one metal insert in the form of a plate. The shape of the mold is adapted to the piston. The plate 52 is positioned in the mold level with the plane wall of the piston and retained by means of nipples, after which plastics material is injected to fill the mold.

In a third variant of the embodiment shown in FIG. 3.C, the cylindrical wall of the piston 18 of the measuring chamber includes a rectangular section metal annulus 54 embedded in the plastics material constituting said piston. The annulus 54 can be pierced with at least one hole 55 to improve the injection molding process and the adhesion of the plastics material to the plate. The method of manufacturing the piston consists of injecting a plastics material around at least one metal insert in the form of an annulus. The shape of the mold is adapted to the piston. The annulus 52 is positioned in the mold level with the cylindrical wall of the piston and retained by means of nipples, after which plastics material is injected to fill the mold.

It is possible to combine the second and third variants to manufacture the piston 18. With the manufacturing method according to the invention, the piston offers higher mechanical strength especially suited to measuring high flowrates.

In a fourth variant of the embodiment shown in FIG. 3.D, the bottom 20 of the lower portion includes a metal plate 56 embedded in the plastics material constituting said lower portion. The plate 56 can be pierced with at least one hole 57 to improve the injection molding process and the adhesion of the plastics material to the plate. The method of manufacturing the lower portion consists of injecting a plastics material around at least one metal insert in the form of a plate. The shape of the mold is adapted to the lower portion. The plate 56 is positioned in the mold level with the bottom and retained by means of nipples, after which plastics material is injected to fill the mold.

In a fifth variant of the embodiment shown in FIG. 3.E, the lateral wall 19 of the lower portion includes a rectangular section metal annulus 58 embedded in the plastics material constituting said lower portion. The annulus 58 can be pierced with at least one hole 59 to improve the injection molding process and the adhesion of the plastics material to the plate. The method of manufacturing the lower portion consists of injecting a plastics material around at least one metal insert in the form of an annulus. The shape of the mold is adapted to the lower portion. The ring 58 is positioned in the mold level with the lateral wall 19 and retained by means of nipples, after which plastics material is injected to fill the mold.

It is possible to combine the fourth and fifth variants to manufacture the lower portion.

With the method of manufacture according to the invention, the bottom and/or the lateral wall are stiffer, which makes the lower portion more durable.

In all of the foregoing description, the plastics material can be charged with glass fibers or carbon fibers, for example.

There is claimed:

1. A method of manufacturing a liquid meter including various components such as a meter body, measuring means which comprise a measuring chamber, its cover or a piston and a mounting ring for a totalizer, said method consisting of manufacturing at least one of said components by an injection molding process using a mold whose shape is adapted to said component to be manufactured and injecting a plastics material around a metal insert intended to form a portion of a core of a portion of one of said components.

2. The manufacturing method claimed in claim 1, consisting of manufacturing said meter body by injecting a plastics material around at least one insert intended to form a portion of said core of said meter body.

3. The manufacturing method claimed in claim 2, wherein said meter body has an upper portion intended for fixing a totalizer, said method consisting of injecting a plastics material around an insert intended to form a portion of said core of said upper portion to reinforce a fixing area for fixing said meter body to said totalizer.

4. The manufacturing method claimed in claim 2, wherein said meter body includes a lateral wall provided with tubes, said method consisting of injecting a plastics material around an insert positioned above an area in which said tubes open into a measuring chamber of said meter body, said insert being intended to form a portion of said core of said lateral wall.

5. The manufacturing method claimed in claim 2, wherein said meter body includes a lateral wall provided with tubes, said method consisting of injecting a plastics material around an insert positioned below an area in which said tubes open into a measuring chamber of said meter body, said insert being intended to form a portion of said core of said lateral wall.

6. The manufacturing method claimed in claim 2, wherein said meter body has a bottom, said method consisting of injecting a plastics material around an insert intended to form a portion of said core of said bottom.

7. The manufacturing method claimed in claim 1, wherein said totalizer is force-fitted onto a ring intended to be fixed to said meter body, said method consisting of injecting a plastics material around a metal insert intended to form a portion of said core of said ring to reinforce the area for fixing said totalizer to said meter body.

8. The manufacturing method claimed in claim 7, wherein said ring is integrated into said totalizer.

9. The manufacturing method claimed in claim 1, wherein said insert is a metal annulus.

10. The manufacturing method claimed in claim 1, wherein said insert is a circular section annulus.

11. The manufacturing method claimed in claim 1, wherein said insert is a rectangular section annulus.

12. The manufacturing method claimed in claim 1, wherein said insert is an annulus with an L-shaped section corresponding to a rectangular section annulus provided with a flange directed toward the interior of said ring.

13. The manufacturing method claimed in claim 1, wherein said measuring means include a measuring chamber having an upper portion provided with a cover nesting over a lateral wall of a lower portion of said measuring chamber, said method consisting of injecting a plastics material around an insert intended to form a portion of said core of said cover.

14. The manufacturing method claimed in claim 1, wherein said measuring means include a measuring chamber comprising a piston having a plane wall, said method consisting of injecting a plastics material around an insert intended to form a portion of said core of said plane wall of said piston.

15. The manufacturing method claimed in claim 1, wherein said measuring means include a measuring chamber comprising a piston with a cylindrical wall, said method consisting of injecting a plastics material around an insert intended to form a portion of said core of said cylindrical wall of said piston.

16. The manufacturing method claimed in claim 1, wherein said measuring means include a measuring chamber having a lower portion formed by a lateral wall and a bottom, said method consisting of injecting a plastics material around an insert intended to form a portion of said core of said bottom.

17. The manufacturing method claimed in claim 1, wherein said measuring means include a measuring chamber having a lower portion formed by a lateral wall and a bottom, said method consisting of injecting a plastics material around an insert intended to form a portion of said core of said lateral wall.

18. The manufacturing method claimed in claim 1, consisting of injecting a plastics material around a metal insert in the form of a plate.

19. The manufacturing method claimed in claim 1, consisting of injecting a plastics material around a metal insert in the form of an annulus.

20. The manufacturing method claimed in claim 1, consisting of injecting a plastics material around an insert in the form of a hexagonal plate.

21. The manufacturing method claimed in claim 1, consisting of injecting a plastics material around an insert pierced with at least one hole.

22. A liquid meter including various components such as a meter body, measuring means that comprise a measuring chamber, its cover or a piston, and a mounting ring for mounting a totalizer, wherein at least a portion of one of said components is manufactured by a manufacturing method as claimed in claim 1.
